(19) United States
(12) Patent Application Publication
(10) Pub. No.: US 2007/0130910 A1
(43) Pub. Date: Jun. 14, 2007

(54) Rotary engine

(76) Inventor: Jung Kuang Chou, Panchiao City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/649,308

(22) Filed: Jan. 4, 2007

Related U.S. Application Data
(63) Continuation-in-part of application No. 11/114,059, filed on Apr. 26, 2005.
Application No. 11/114,059 is a continuation-in-part of application No. 10/900,192, filed on Jul. 28, 2004, now abandoned.
Application No. 10/900,192 is a continuation-in-part of application No. 10/392,859, filed on Mar. 21, 2003, now abandoned.

(51) Int. Cl. F02C 5/00; F02C 3/00

(52) U.S. Cl. 60/39.44

(57) ABSTRACT

A rotary engine includes a round wheel having a shaft pivoted on a frame, wherein the round wheel is provided with a plurality of pockets. At least one block is located adjacent a round surface of the wheel and maintains a stable contact therewith to a suitable oblique angle between the block and the wheel. The block has an aperture, a combustion chamber, and a power room, which are opposite to pockets of the wheel. A roller is fixed on the frame to support and maintain the stability of the block. The wheel is continuously rotated for output of an efficient kinetic force responsive to expanding gases from an explosive ignition of fuel in the combustion chamber that pushes the wheel to rotate and exhaust the gases into the power room to provide an auxiliary active force.

This application is a continuation-in-part of U.S. application Ser. No. 11/114,059 filed on 26 Apr. 2005, which is a CIP of U.S. application Ser. No. 10/900,192 filed on 28 Jul. 2004 being a continuation-in-part of U.S. application Ser. No. 10/392,859 filed on 21 Mar. 2003, which had claimed priority on Taiwanese application filed on 3 Apr. 2002.

### FIELD OF THE INVENTION

The present invention relates to a rotary engine, and especially to an invented and novel apparatus having absolute new structure for providing continuous horsepower by high-pressured gases as an efficient engine.

### BACKGROUND OF THE INVENTION

There are various kinds of engines for providing kinetic force in different mechanic apparatus. Each engine is designed for a certain purpose in utilizing a related machine with a specific way to supply the horsepower. It is popular that most land vehicles use reciprocating piston engines, which are characterized in that their torques are normal in low rotating speed. The known reciprocating piston engine generally must have a suitable clearance between the piston and the cylinder thereof for rotation, thereby, it should be cooled to be controlled at the state of low-temperature rotation to prevent from strain by expansion and contracting by heating and cooling, the total heat consumption thereof is about 60% of the total amount of fuel, and the effective rate of use is only about 30%.

Further, an intermittent intake system is not easy in controlling the mixture ratio of air with fuel, a low combustion temperature is subject to air contamination, and each time the cylinder has a larger explosion amount, higher noise, larger vibration, more complicated control, and relatively, its structure is heavier, bigger and more consolidated. By virtue that explosion has some limitations, the internal diameter of the cylinder is perfectly not larger than 15 cm; hence a gasoline engine with larger horsepower mostly is composed of multiple cylinders, the performance of acceleration of it is inferior, it is added with mixed gas once every one or two turns of rotation, the amount that can be added is limited, and is hard to elevate the combustion temperature for increasing efficiency.

### SUMMARY OF THE INVENTION

The present invention is to provide a rotary engine getting rid of the limitation of a conventional piston engine, which can avoid the defects of the limitation by the low temperature rotation, the intermittent gases intake and discharging to elevate the combustion temperature for increasing efficiency.

A character of the present invention is to solve the problem of thermal expansion in the engine, wherein it can keep the pressure and friction between the block and the wheel approach to zero in order to reduce the force of resistance and to increase its horsepower. The effect is composed of the block and the point of the support, between which a suitable angle is formed relating to the round wheel, which can be supported by a roller.

According to the principal theory of combustion, the traditional method uses low-density mixture gases, wherein the distance between each oil molecule is far that is difficult for being ignited. It should be compressed to a volume about one over nine (1/9) to increase the temperature of the mixture fuel, while the oil molecules are so close to be ignited by each other upper than 300° C. for explosion. The present invention uses an input mixture fuel, which is continuously burn to get high pressure and temperature that obtains efficient combustion with quick reaction and will be available as using various fuels, wherein the conditions of compressed ratio, air density, and oil ratio are not so important, whatever the air should be offered sufficiently. And it is the most important character of this invention that expansion airflow after combustion may efficiently active the wheel to run.

Now, accompanying with the following drawings, the character of the present invention will be described here and after.

### BRIEF DESCRIPTION OF THE DRAWINGS

FIG. 1 is a perspective view showing a rotary engine according to the present invention.

FIG. 2 is an exploded perspective view of FIG. 1 showing parts of the engine.

FIG. 3 is a cross-sectional plan view showing the contact plane of FIG. 2.

FIG. 4 is a top cross-sectional plan view of FIG. 1.

FIGS. 5 to 7 are views of FIG. 4 showing the acting processes according to the present invention.

FIG. 8 is a plan view illustrating the vector of dynamic analysis of the present invention.

FIG. 9 is a perspective view showing a controlling apparatus of a power room according to the present invention.

FIG. 10 is a perspective view of FIG. 9 showing an opening action of the apparatus.

FIG. 11 is a cross-sectional plan view showing a modified embodiment according to the present invention.

FIG. 12 is a perspective view showing an exemplary embodiment of FIG. 11.

### DETAILED DESCRIPTION OF THE PREFERRED EMBODIMENT

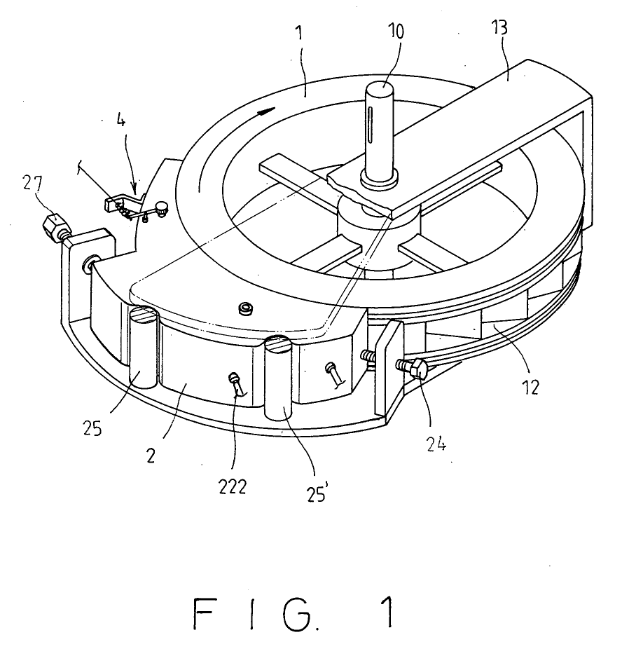

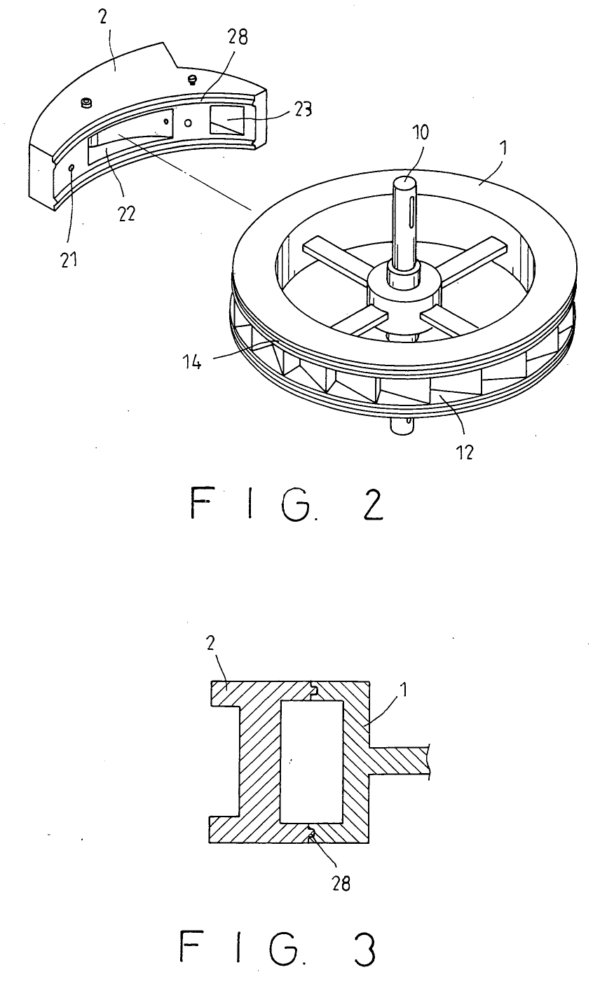

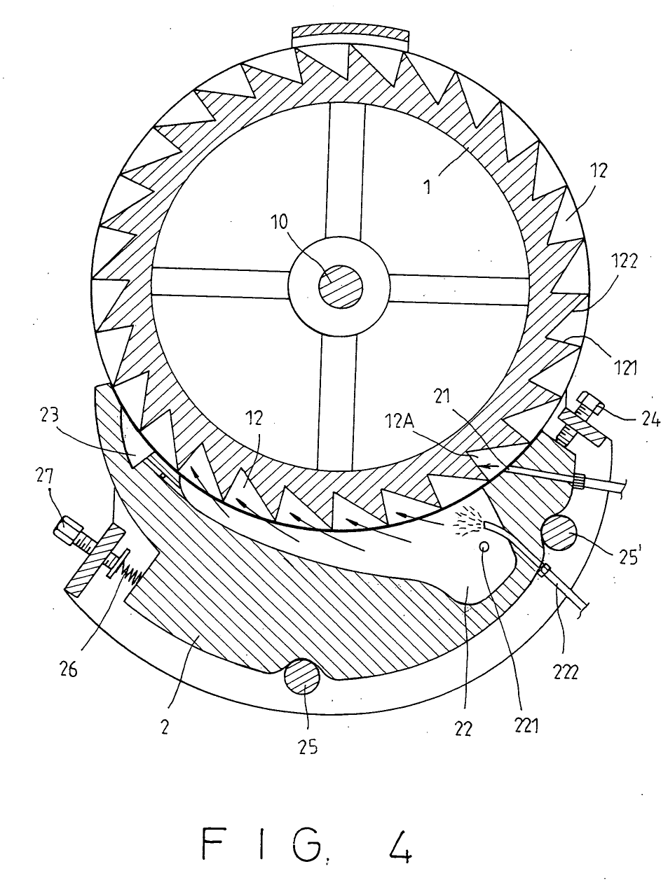

Please referring to FIG. 1 to 4, the present invention includes a round wheel (1), of which a shaft (10) is pivoted on a frame (13) to provide kinetic force during rotating. The round wheel (1) is provided with a plurality of pockets (12), each of which has a leading plane (121) to align with the radius of the wheel (1) and an inclined tracer plane (122). The inner surface of the wheel (1) and the pockets (12) can be coated with a thin layer of pottery and porcelain. At least one block (2) is located at a lateral side or round surface of the wheel (1) with a suitable oblique angle to keep stable contact with the round surface of the wheel (1) by use of an elastic force provided by a spring (26) mounted on a screw (27) connected on the frame (13), wherein the block (2) is provided with a convex ring (28) for fitting with concave portion (14) formed on the wheel (1), as shown in FIGS. 2 and 3. The block (2) is also provided with an intake aperture (21), a combustion chamber (22), and a power room (23), which are opposite to pockets (12) of the wheel (1). Two rollers (25) and (25′) are provided on the frame (13) to support and maintain the block (2) in stable, wherein the second roller (25′) can be moveable by connecting an elastic apparatus inside (not shown). Further, a screw (24) is provided to resist the reaction force of the block (2) and it can also be regulated.

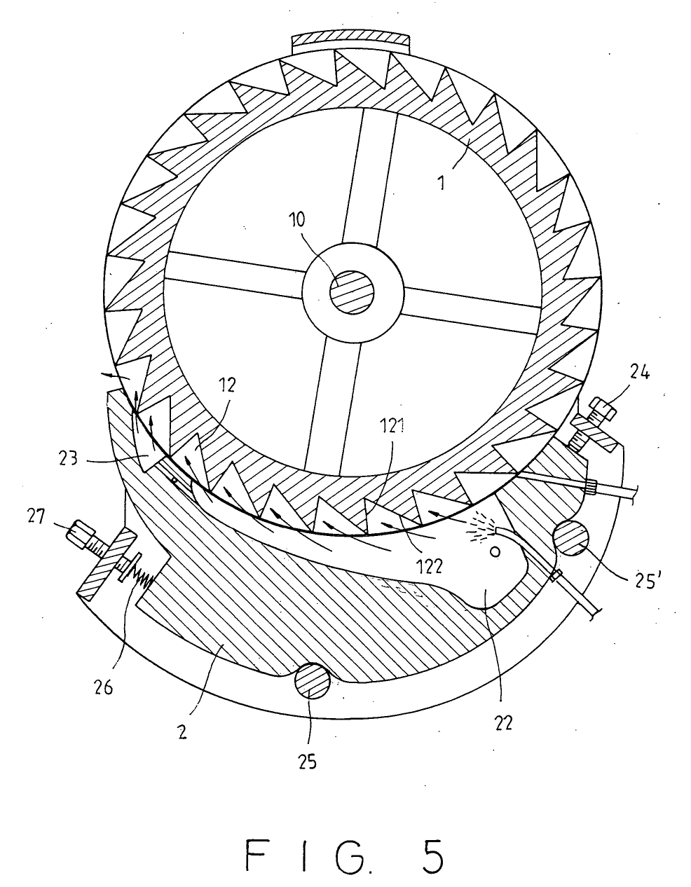

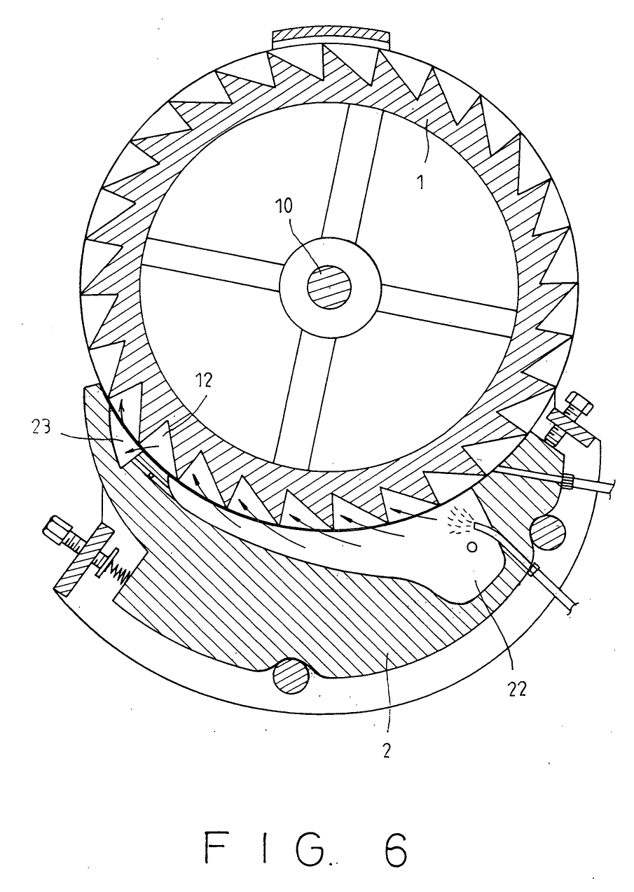

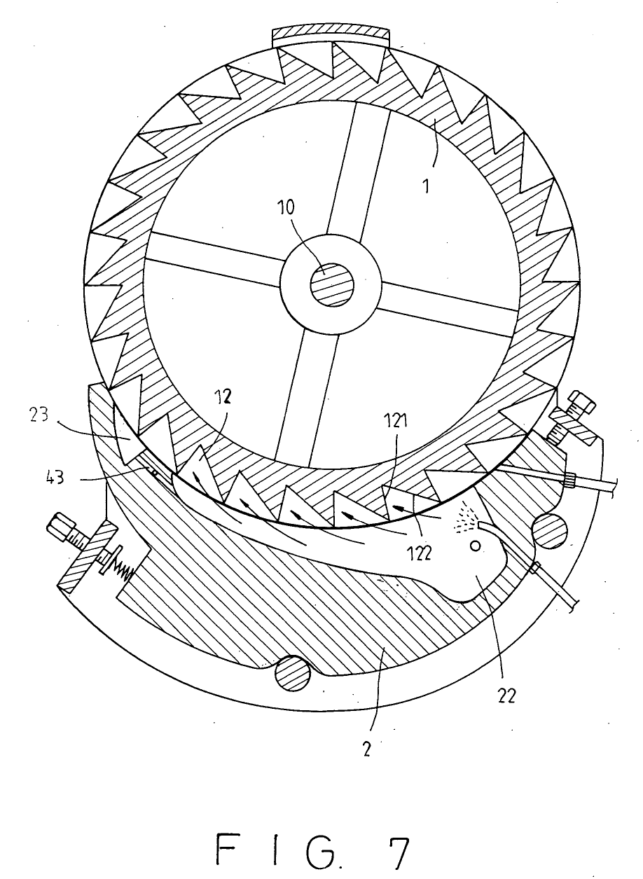

In processing, when the high-pressured air is input from the intake aperture (21) into a related pocket (12A), as shown in FIGS. 4 to 7, a pressure of the direct flow can motivate the wheel (1) to start rotating that provides an initial acting force (or a known motor starter equipment is able to cause this action, not shown). As the said pocket (12A) with pressured air moves to communicate with the combustion chamber (22), the fuel injected from an inlet pipe (222) can be ignited quickly by a spark plug (221) provided thereof. An explosion is occurred and an expansion gases including CO2 and steam are produced to force on the leading plane (121) and to motivate the wheel (1) rotating directly, meanwhile the airflow will be just projected to the leading plane (121) at a vertical direction with effective acting force and almost parallel to the tracer plane (122) with acting force being approach to zero. To explain this conclusion, please refer to FIG. 8; it shows the vectors (forces) of dynamic analysis, wherein by the tangent line A-A′ section, the left side vector C is equal to the right side vector B. Vector on the wall W is zero and vector A is bigger than zero. Finally, the wheel (1) can certainly rotate along the indication of the arrows as in the figures and the multiple leading planes of the pockets obtain more torques for facilitating the wheel to rotate. Therefore, since the block (2) is kept in stable by the first roller (25), the burning gases becoming a speedy airflow in high pressure will motivate the wheel (1) to rotate because it is the only direction for taking out and releasing the pressure of the explosion gases. In details, continuous movements of the present invention are shown from FIGS. 4 to 7, wherein the explosion gases with high pressure will be taken out from the pocket (12) near to the end of the combustion chamber (22), through the power room (23), and then outside. During this action, it can be found that the airflow in the power room (23) is just forcing at a leading plane of the related pocket. In other words, it becomes an exchange status between the movement of the pockets (12) and the power room (23). As the former pocket is opened to outside releasing gases from the power room at first moment, the later pocket is closed not to reach the power room, and as the later pocket is opened to power room, the former pocket is closed to obtain the high pressured gases therein for motivating the wheel, in which the power room obtains a closing-opening exchange status. A character of this on-off system is that the connecting portion between the combustion chamber (22) and the power room (23) is shorter than the opening of the pocket (12) that will be convenient for controlling and exhausting gases but will not loss any energy in due course. During this movement, the speedy airflow can motivate the wheel (1) to run with no doubt. It can be understood that the speed of the airflow near the output end of the combustion (22) will be faster because of its smaller cross section, which occurs a high pressure differential thereof. The gases in the space of the combustion chamber (22) can be expansion in volume, exhausted into the power room and released outsides that it is not a closed status obviously.

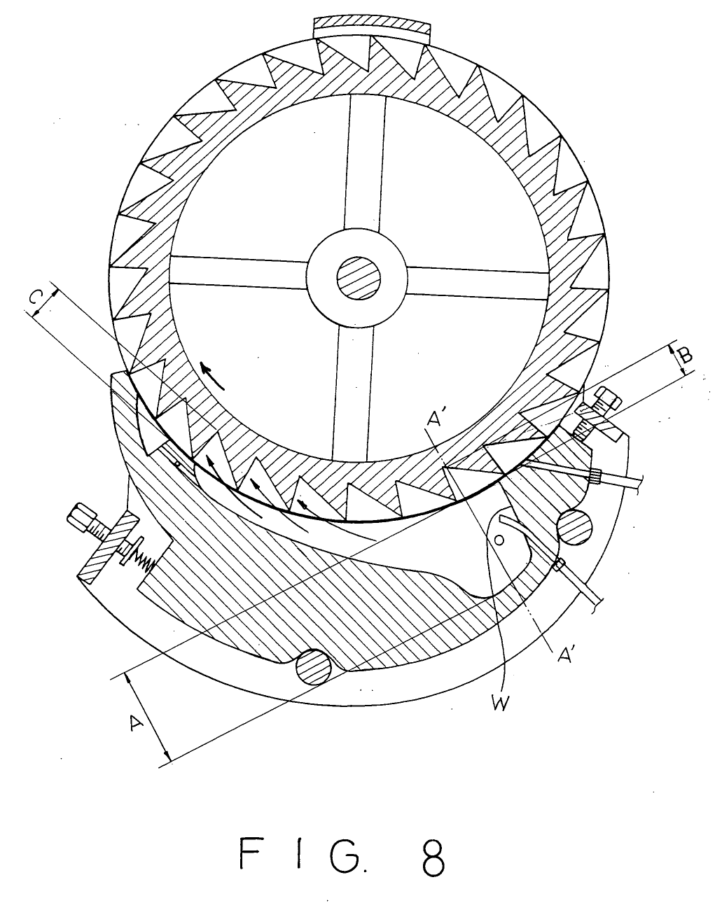

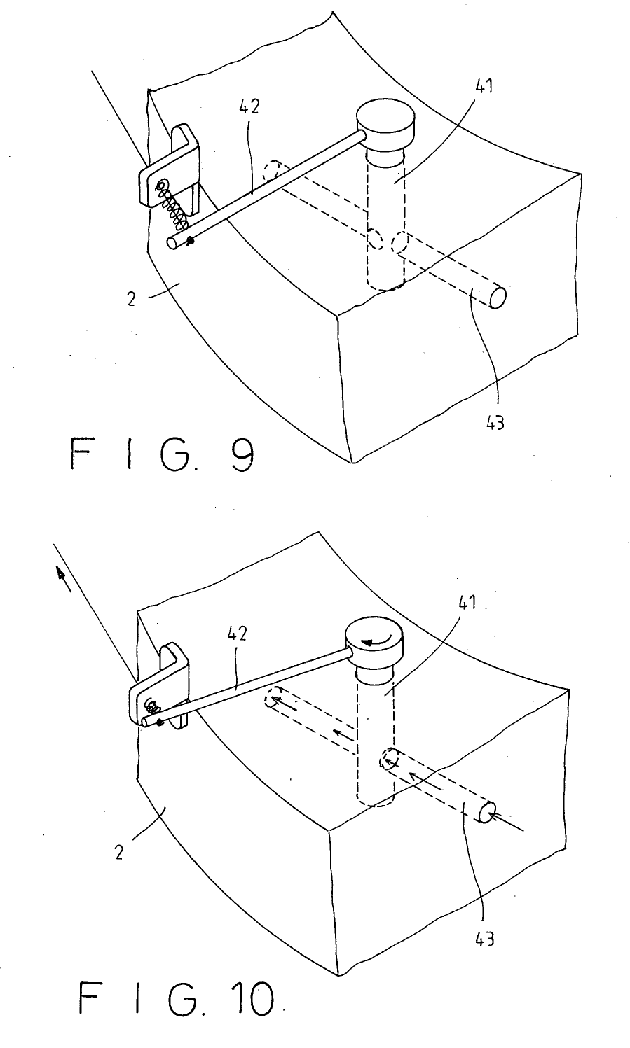

Furthermore, accompanying with FIGS. 1, 7, 9 and 10, a controlling apparatus (4) having a pin (41) and a lever (42) is provided at a middle position on a channel (43), which communicates the combustion chamber (22) and the power room (23). As desirable, it is possible to pull the lever (42) and rotate the pin (41) for opening the channel (43) that helps some of the expansion gases may enter the power room (23) to enter a corresponding pocket (12) of the wheel (1). The released gases in the pockets (12) can then provide an auxiliary power to push the wheel (1) rotating with large torque at the moment. It can be understood that by use of said repeated processes of explosion, the wheel (1) rotates and outputs the continuous kinetic force for utilization efficiently.

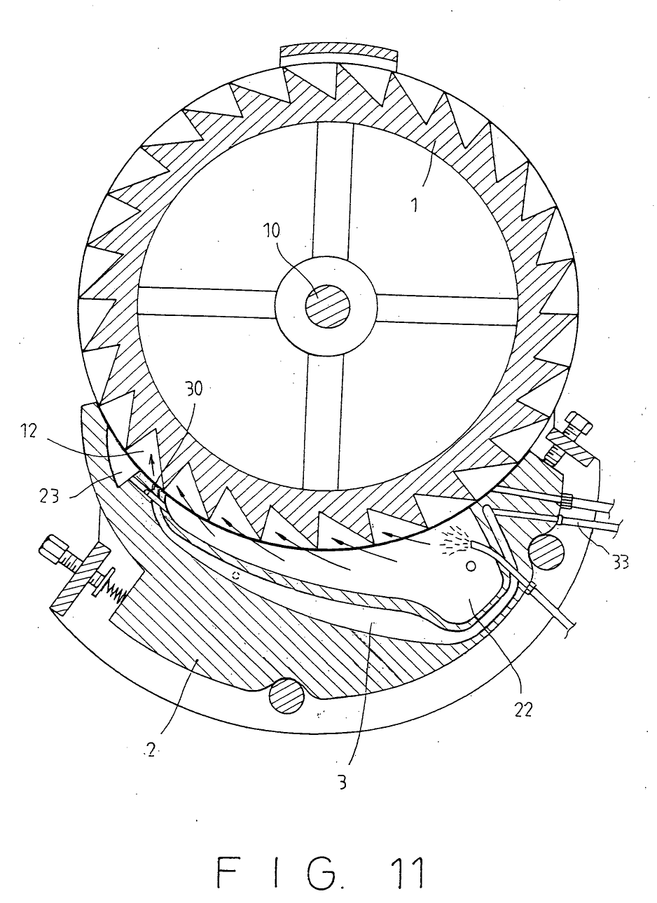

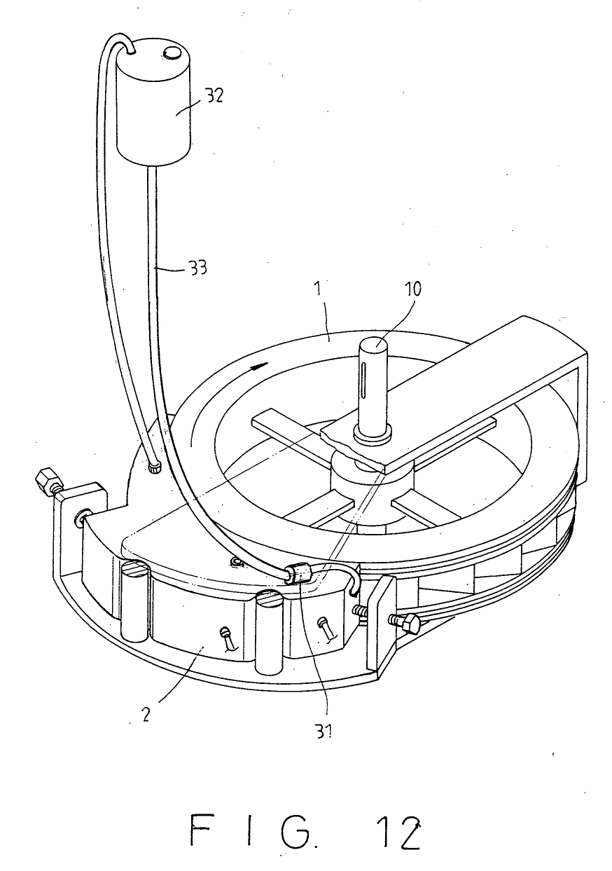

Please referring to FIGS. 11 and 12, they show the views of another modified embodiment of a rotary engine according to present invention, wherein a temperature controller (not shown) is provided in a cooling room (3) for controlling an electrical valve (31) to spray water from a pipe (33) connected to a tank (32) into the cooling room (3) when the temperature in the cooling room (3) reaches to a preset level. When the cooling water becomes steam after cooling the combustion chamber (22) and the steam can be sprayed from its outlet vent (30) into the power room (23) to push a corresponding pocket (12) that facilitates the rotation of the wheel (1).

In conclusion, the present invention discloses a rotary engine to get rid of the drawbacks resided in a conventional engine and to elevate the combustion temperature for increasing efficiency of the rotary engine that is novel and utilizable.

The embodiment described is only for illustrating the present invention, it will be apparent to those skilled in this art that various modifications or changes without departing from the spirit of this invention shall also fall within the scope of the appended claims.

I claim:

1. A rotary engine including a round wheel having a shaft pivoted on a frame to provide kinetic force during rotating, wherein the round wheel being provided with a plurality of pockets, each of which has a leading plane to align with the radius of the wheel and an inclined tracer plane, and at least one block being located at a lateral side or round surface of the wheel being kept stable contact with the round surface of the wheel by use of elastic force provided by a spring connected on a screw mounted on the frame, wherein the block is placed its external with a suitable oblique angle relating to the round wheel and is supported by a roller being fixed on the frame to support and maintain the block in stable, and the block having an intake aperture, a combustion chamber, and a power room, which are opposite to pockets of the wheel; action forces to the pockets and wheel for rotating being produced by use of the high-pressured inlet air from an intake aperture, expanding gases after explosion of the injected fuel being ignited in the combustion chamber, and the high-pressured gases exhausted into the power room to push the pocket of the wheel rotating for output kinetic force.

2. The rotary engine as claimed in claim 1, wherein the block is provided with a temperature controller in the cooling room for controlling an electrical valve to spray water from a pipe of a tank into the cooling room as the temperature in the room reaches a preset level, and the cooling water becoming steam after cooling the combustion chamber and being sprayed from its outlet vent into the power room to push a corresponding pocket that facilitates the rotation of the wheel.

3. The rotary engine as claimed in claim 1, wherein the block is provided with a controlling apparatus having a pin and a lever is provided at a middle position on a channel, which communicates the combustion chamber and the power room that the sudden high-pressured gases is released by pulling the lever and rotate the pin to open the channel, which helps some of the expansion gases enter the power room quickly and motivate the wheel during releasing outsides.

4. The rotary engine as claimed in claim 1, wherein the movement of the pocket and the power room becomes an exchange status, as the former pocket is opened to outside releasing gases from the power room at first moment, the later pocket is closed not to reach the power room, and as the later pocket is opened to power room, the former pocket is closed to obtain the high pressured gases therein for motivating the wheel, in which the power room obtains a closing-opening exchange status.
